(19) United States
(12) Patent Application Publication
(10) Pub. No.: US 2023/0358511 A1
(43) Pub. Date: Nov. 9, 2023

(54) SYSTEMS AND METHODS FOR PROTECTION AGAINST BLAST AND BALLISTIC THREATS

(71) Applicant: Advanced Blast Protection Systems, LLC, dba SALERIA, Houston, TX (US)

(72) Inventors: James Arthur Warren, Houston, TX (US); Jason Lovaine Blaylock, Houston, TX (US)

(21) Appl. No.: 18/314,738

(22) Filed: May 9, 2023

Related U.S. Application Data
(60) Provisional application No. 63/339,903, filed on May 9, 2022.
(60) Provisional application No. 63/341,998, filed on May 13, 2022.

(51) Int. Cl. F41H 5/24; F41H 11/08

(52) U.S. Cl. CPC F41H 5/24; F41H 11/08

(57) ABSTRACT

A protective barrier system designed to protect against high-energy events, such as impacts from ballistic threats or blasts. In one embodiment, the protective barrier system comprises a blast mitigation panel in the front (on the threat side of the barrier), a ballistic resistant panel in the back (on the asset side of the barrier), and a frame that is configured to incorporate the blast mitigation panel and ballistic resistant panel, and stand the panels upright so as to form a barrier. The blast mitigation panel and ballistic resistant panel are modular and are easily attached to and detached from the frame to create a protective barrier that can be easily customized to protect structures or assets of nearly any shape or size from both blasts and ballistics. For example, another embodiment is a protective barrier system that may be used as body armor or personal protection for an individual.

### RELATED APPLICATION

The present application claims priority to U.S. Provisional Patent Application No. 63/339,903 to Warren et al., entitled “Systems and Methods for Protection Against Blast and Ballistic Threats,” filed on May 9, 2022, and U.S. Provisional Patent Application No. 63/341,998 to Warrant et al., entitled “Systems and Methods for Personal Protection Against Blast and Ballistic Threats,” FILED ON May 13, 2022. The entireties of both provisional applications is fully incorporated by reference herein.

### BACKGROUND OF THE DISCLOSURE

### Field of the Disclosure

The present disclosure relates to systems and methods for protecting objections, structures, and individuals against high energy events, such as impacts from ballistic threats, blasts, or fragmentation, and, more specifically, a multi-layered barrier system for absorbing or protecting assets against these events.

### Description of the Related Art

Options of devices or systems presently available for blast and ballistic protection are based around concrete walling, sandbags, dry-stack walls, and gabion baskets (typically consisting of a welded wire mesh frame with a geotextile liner inside filled with sand, soil, gravel, or rocks), sometimes referred to as “HESCO” or “HESCO gabion baskets” with HESCO being a registered trademark of Hesco Bastion Limited (a UK company). The term “Hesco” is sometimes used by those skilled in the art to generally refer to gabion baskets. HESCO gabion baskets provide protection due to their bulk and mass. To put these systems in place and to use them requires significant logistical planning and machinery to construct. In the case of HESCO gabion baskets, large amounts of earthworks and aggregate fill are required. Moreover, once the protection systems or devices are set up, they are difficult to move and offer little flexibility for any change in circumstances. When in use, concrete walling and gabion baskets can reduce the amount of useable real estate, and the baskets or sandbags require substantial amounts of earthworks and aggregate fill that may not be readily available. These systems or devices also require significant work in removal, clearing, and cleaning when no longer needed.

There is a need for lightweight, transportable, easily assembled/disassembled, and relatively compact temporary barriers to provide protection against ballistics and explosive blasts, both for domestic situations in the United States and military deployments. Law enforcement, emergency responders, planners of large events, and defense agencies need to be able to implement effective perimeter or personal protection at short notice with the use of minimal and/or hand tools rather than heavy equipment.

### SUMMARY OF THE DISCLOSURE

One embodiment of a protective barrier system according to the present disclosure system comprises a blast mitigation panel in the front (on the threat side of the barrier), a ballistic resistant panel in the back (on the asset side of the barrier), and a frame that is configured to incorporate the blast mitigation panel and ballistic resistant panel, and stand the panels upright so as to form a barrier.

Another embodiment of a protective barrier system according to the present disclosure comprises a blast mitigation panel in the front (on the threat side of the barrier), a ballistic resistant panel in the back (on the asset side of the barrier), and a mechanism on the ballistic resistant panel that may be used by an individual to hold or utilize the protective barrier system.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows a front view of a protective barrier according to an embodiment of the present disclosure;

FIG. 2 shows a front perspective view of the embodiment of FIG. 1;

FIG. 3 shows a back view of the embodiment of FIG. 1;

FIG. 4 shows a back perspective view of the embodiment of FIG. 1;

FIG. 5 shows a right-side view of the embodiment of FIG. 1;

FIG. 6 shows various perspective views of a protective barrier system according to an embodiment of the present disclosure;

FIG. 7 shows a front perspective view of a protective barrier system with anti-climb mesh according to an embodiment of the present disclosure;

FIG. 8 shows a back perspective view of a protective barrier system with a ramp or platform according to an embodiment of the present disclosure;

FIG. 9 shows a front perspective view of a protective barrier system according to another embodiment of the present disclosure;

FIG. 10 is a photograph of an embodiment of the protective barrier system according to the present disclosure;

FIG. 11 is a drawing of an embodiment of the protective barrier system according to the present disclosure;

FIG. 12 is a photograph of an embodiment of the protective barrier system according the present disclosure;

FIG. 13 is a computer design drawing of another embodiment of the protective barrier system according to the present disclosure; and

FIG. 14 is a photograph of another embodiment of the protective barrier system according to the present disclosure.

### DETAILED DESCRIPTION OF THE DISCLOSURE

In the following detailed description, numerous specific details are set forth in order to provide a more thorough understanding of embodiments incorporating features of the present disclosure. However, it will be apparent to one skilled in the art that devices and methods according to the present disclosure can be practiced without necessarily being limited to these specifically recited details.

Throughout this disclosure, the embodiments illustrated should be considered as exemplars, rather than as limitations on the present disclosure. As used herein, the term “composition,” “device,” “structure,” “method,” “system,” “disclosure,” “present composition,” “present device,” “present structure,” “present method,” “present system,” or “present disclosure” refers to any one of the embodiments of the disclosure described herein, and any equivalents. Furthermore, reference to various feature(s) of the “composition,” “device,” “structure,” “method,” “system,” “disclosure,” “present composition,” “present device,” “present structure,” “present method, “present system,” “present apparatus,” or “present disclosure” throughout this document does not mean that all claimed embodiments or methods must include the reference feature(s).

Furthermore, any element in a claim that does not explicitly state “means for” performing a specified function, or “step for” performing a specific function, is not to be interpreted as a “means” or “step” clause as specified in 35 U.S.C. § 112, for example, in 35 U.S.C. § 112(f) or pre-AIA 35 U.S.C. § 112, sixth paragraph. In particular, the use of “step of” or “act of” in the claims herein is not intended to invoke the provisions of 35 U.S.C. § 112.

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Furthermore, relative terms such as “left,” “right,” “front,” “back,” “top,” “bottom′” “forward,” “reverse,” “clockwise,” “counter-clockwise,” “outer,” “inner,” “above,” “upper,” “lower,” “below,” “horizontal,” “vertical,” and similar terms, have been used for convenience purposes only and are not intended to imply any particular fixed direction. Instead, they are used to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although ordinal terms, e.g., first, second, third, etc., may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments as described in the present disclosure can be described herein with reference to view illustrations that are schematic in nature. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

It is understood that when a first element is referred to as being “between” or “interposed between” two or more other elements, the first element can be directly between the two or more other elements or intervening elements may also be present between the two or more other elements. For example, if a first element is “between” or “interposed between” a second and third element, the first element can be directly between the second and third elements with no intervening elements, or the first element can be adjacent to one or more additional elements with the first element and these additional elements all between the second and third elements.

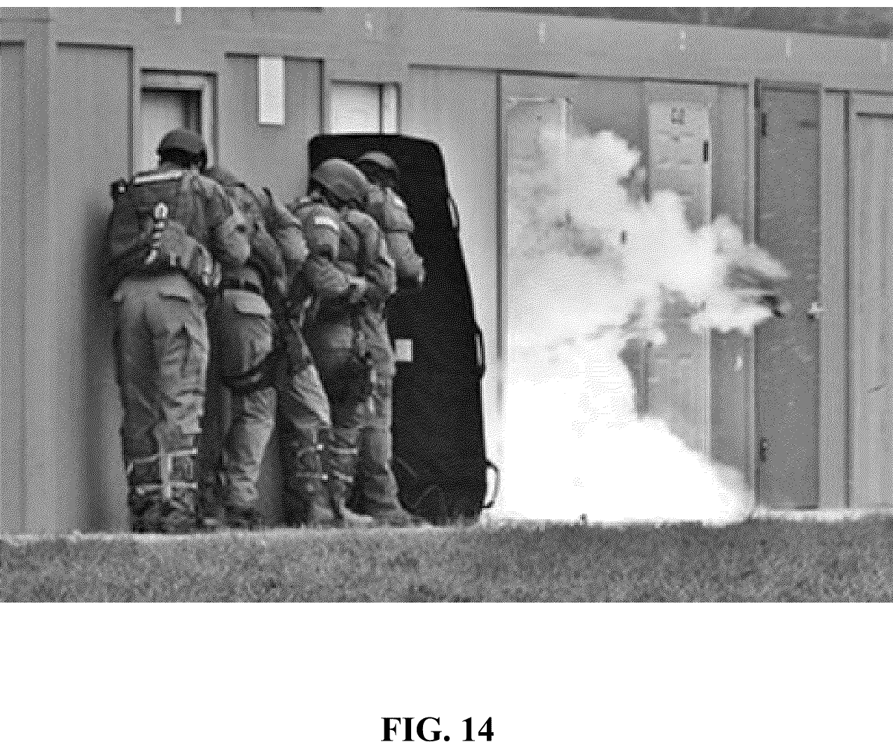

Embodiments of the present disclosure include blast mitigation and ballistic resistant panels, shields, and appliques arranged together to form a protective barrier that absorbs, diffuses, mitigates, and/or protects personnel or assets on an asset side of the barrier against high-energy events such as blasts and fragmentations from explosions or impacts from ballistic threats on a threat side of the barrier. In some embodiments, the panels, shields, and appliques can be worn as personal body armor, as shown in FIG. 14. Certain embodiments are configured with a mechanism that allows the personal body armor to be held or connected to the user, such as a hook-and-loop mechanism.

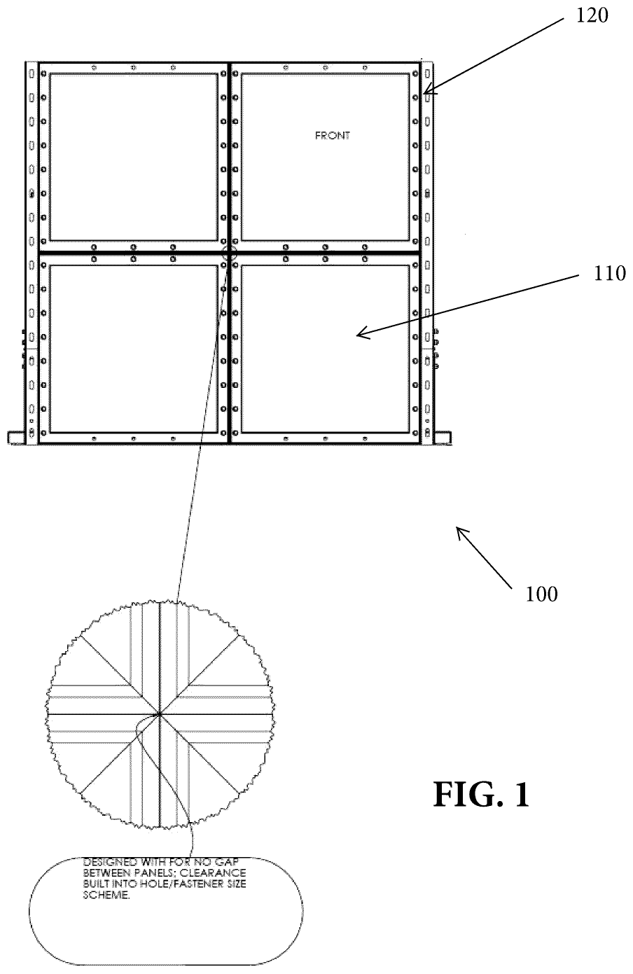

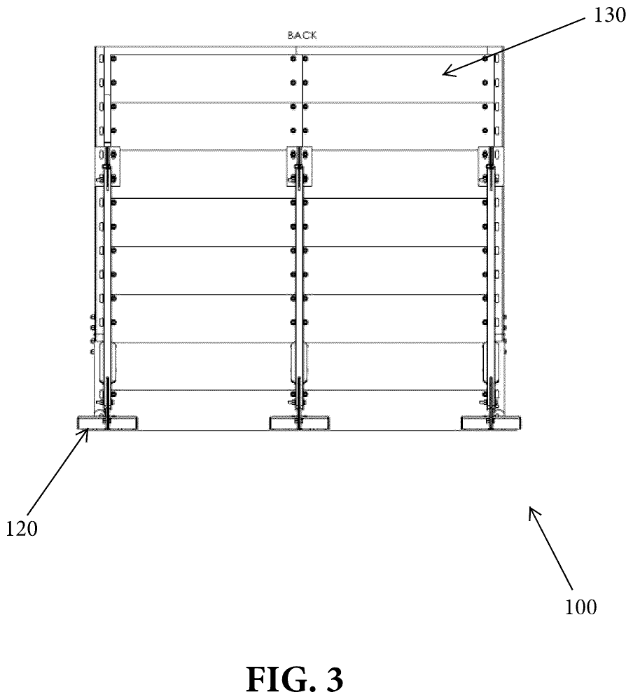

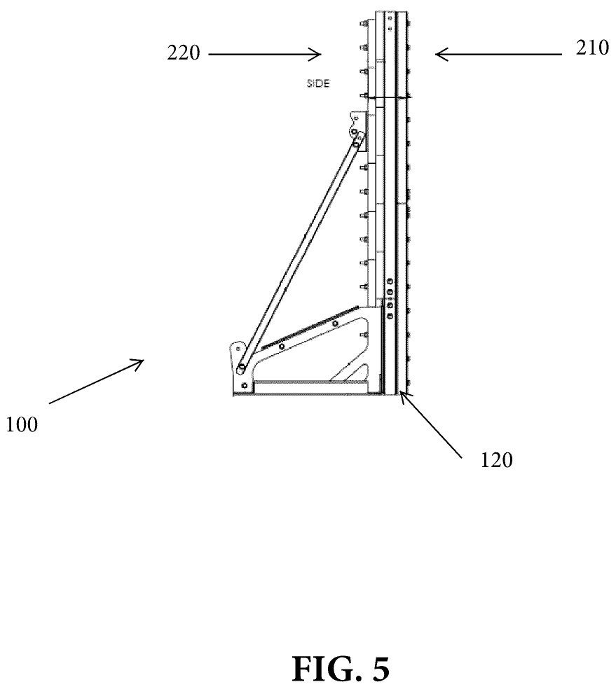

FIGS. 1-5 show various views of the protective barrier 100 with blast mitigation panels 110 on the front of the system 210 (i.e., the “threat side”), ballistic resistant panels 130 on the back of the system 220 (i.e, the “asset side”), and a frame 120 that holds the panels upright to form the protective barrier 100.

In the particular embodiment shown in FIGS. 1-5, the blast mitigation panels 110 have length and height dimensions of Oft by 4 ft, but it is understood that blast mitigation panels 110 having various dimensions can be used and that the size of the blast mitigation panel 110 may be dictated by the intended application and/or positioning. Moreover, in the particular embodiment shown in FIGS. 1-5, the ballistic resistant panels 130 have length and height dimensions of 3.9 ft×1.2 ft, but it is understood that ballistic resistant panels 130 having various dimensions can be used and that the size of the ballistic resistant panel 130 may be dictated by the intended application and/or positioning.

The blast mitigation panel 110 comprises multiple layers of various materials that, working together, mitigate shock transmission and hold heat from a fireball (e.g., a blast) in a solid state. These layers may comprise, for example, aluminum foam, foam titanium, foam copper, closed-cell polymer foams, pressed inert powder, aerogels, cement-based fiber board, drywall, pressed alkali metal compounds, closed-cell polyurethane foam, pumice, vermiculite, perlite, pressed low-melting-point glass beads, e-glass, aramid fiber composites, carbon fiber, aluminum, titanium, and steel. Other suitable materials that mitigate shock transmission and dissipate energy may also be used. Many different combinations of materials in the layers are possible.

In one embodiment, a blast mitigation panel 110 consists of several layers of material arranged in a sequence starting from the innermost layer and progressing outwards to the exterior. Thus, the innermost layer is termed as the first layer with the ordinal-termed layers ascending as the layers get farther away from the interior. In this particular embodiment, the first layer comprises an aluminum foam having a suitable density, the second layer comprises pressed inert powder, the third layer comprises an E-glass, and the fourth and final layer comprises a polyurethane.

The density between layers of the blast mitigation panel 110 may differ in order to increase the time it takes for the panel to reach a steady-state equilibrium, allowing the panel more time to react structurally. Similarly, the thickness of the layers may differ and be determined by the anticipated threat level.

The ballistic threat panel 130 includes a polymer containing dispersed aggregate comprising an aggregate bound by an elastomer. The ballistic threat panel 130 is designed to defeat impinging projectiles by converting the kinetic energy in the projectile to damage in the aggregate and the elastomer and increasing the thermal energy in the composite material and the projectile via frictional heating. In the preferred embodiment, the composite material of the ballistic threat panel comprises certain kinds of rocks encapsulated (or bound) in a hyper-elastic polymer, such as polyurethane. However, it is understood that many different aggregate/elastomer combinations are possible.

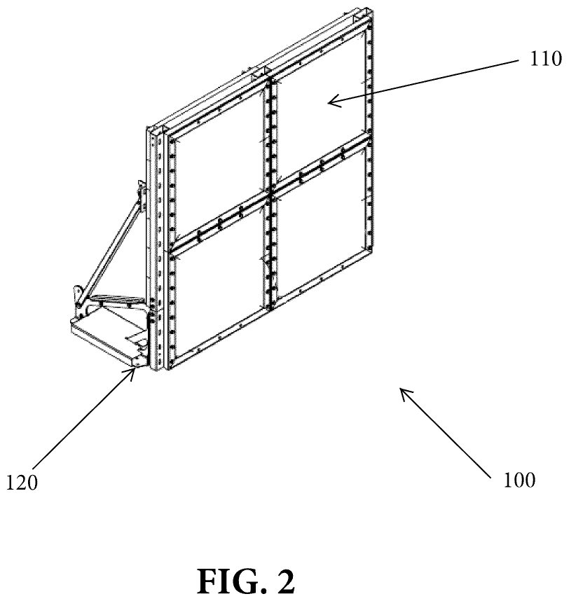

The bulk density of the material for the ballistic resistant panel 130 should be selected such that performance of the panel is adequate for defeating a particular projectile threat but also such that the manufacturing process is feasible and economical. Moreover, it is possible to build ballistic resistant panels 130 having many different shapes. In the preferred embodiment, as shown in FIG. 2, the ballistic resistant panels 130 are shaped like planks that may be fit together to build structures such as walls, ceilings, or buildings. These panels are relatively lightweight and thus easily transported for assembly, maintenance, and replacement.

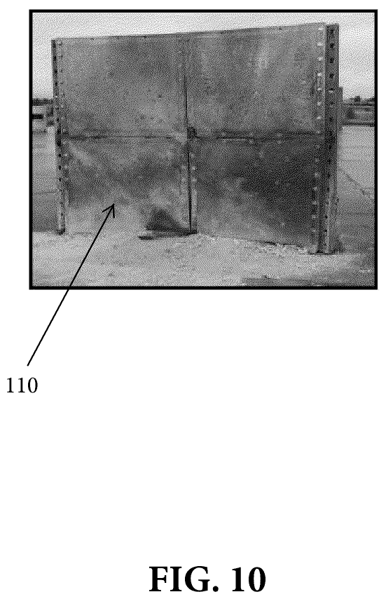

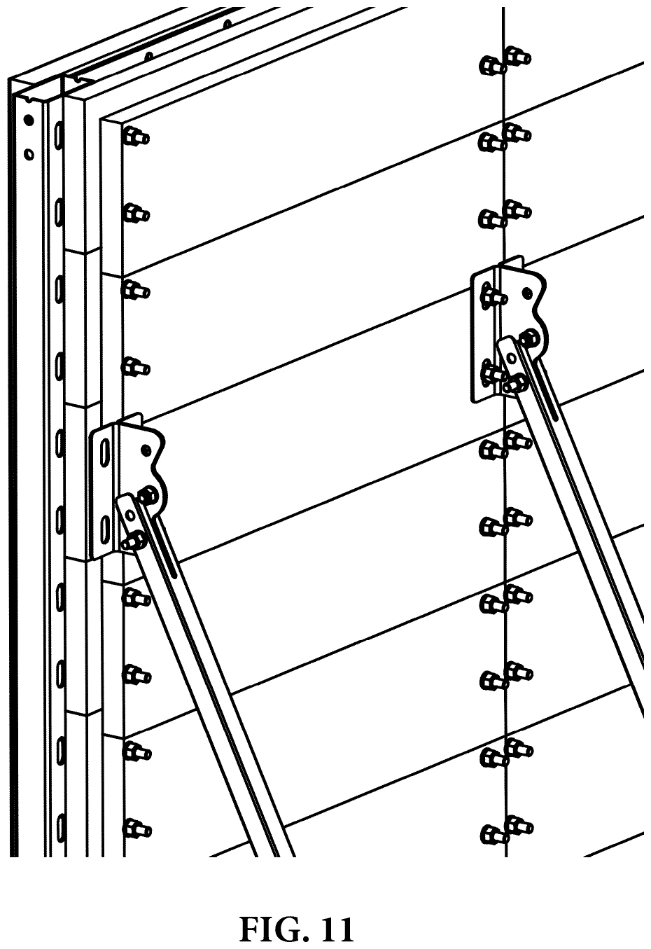

As mentioned above, the blast mitigation panels 110 and ballistic resistant panels 130 may be incorporated into metal (e.g., steel) frames 120 for deployment in the field. Exemplary embodiments of the frames 120 incorporated into the protective barrier system are shown in FIGS. 1-13. In the particular embodiment shown in FIGS. 1-5, the frames 120 have a height of 6 ft, but it is understood that frames 120 having various dimensions can be used and that the size of the frame 120 may be dictated by the intended application and/or positioning.

The framing 120, and thus the protective barrier 100, is configured such that it can be constructed on both hard and soft ground conditions. The blast mitigation panels 110 and the ballistic resistant panels 130 are easily attached to and detached from the frame 120 to create a portable modular protective barrier system 100 that can be readily deployed in the field and customized to protect structures or assets of nearly any shape or size.

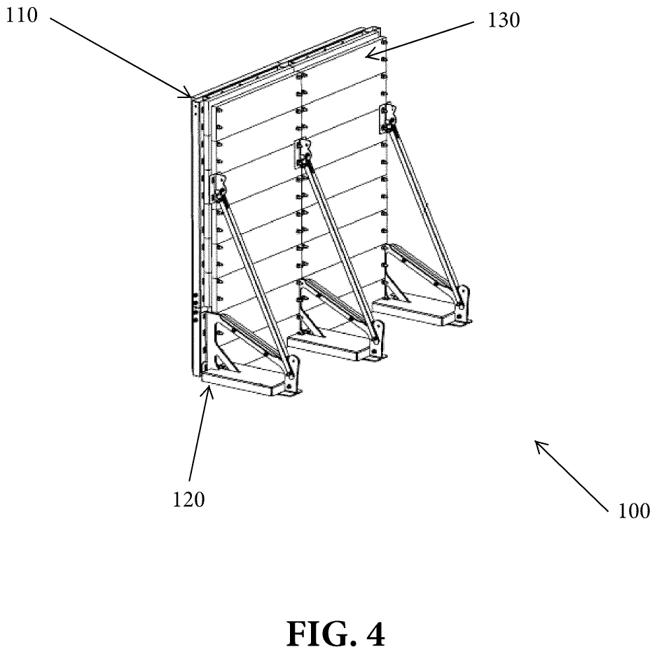

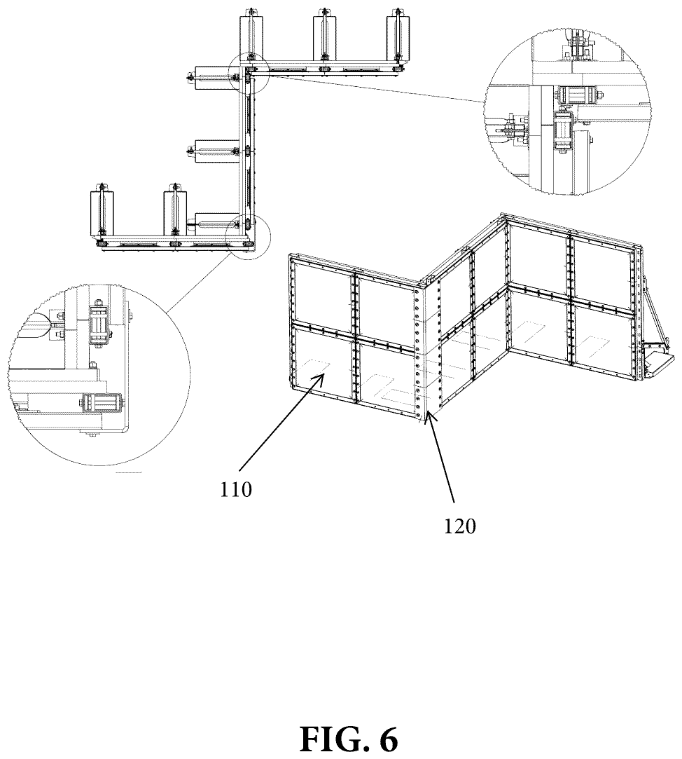

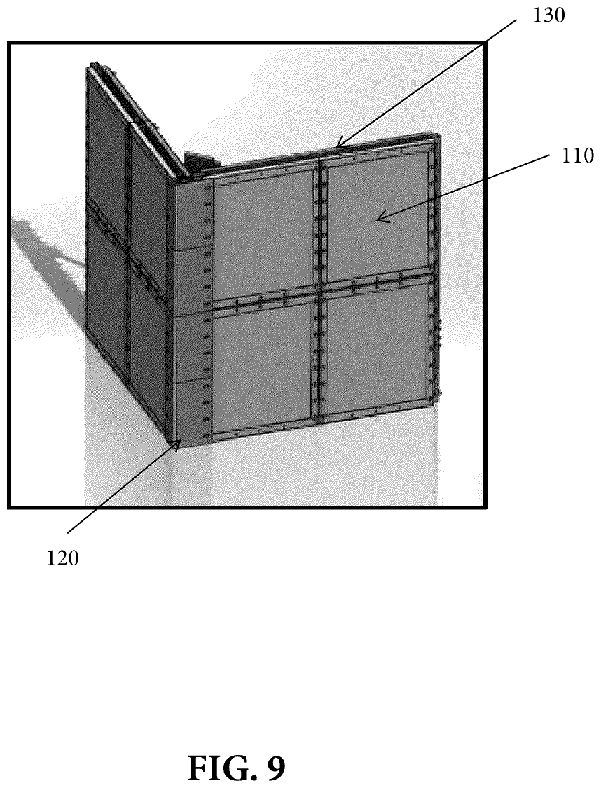

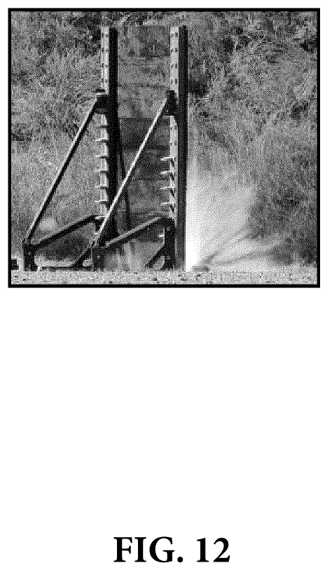

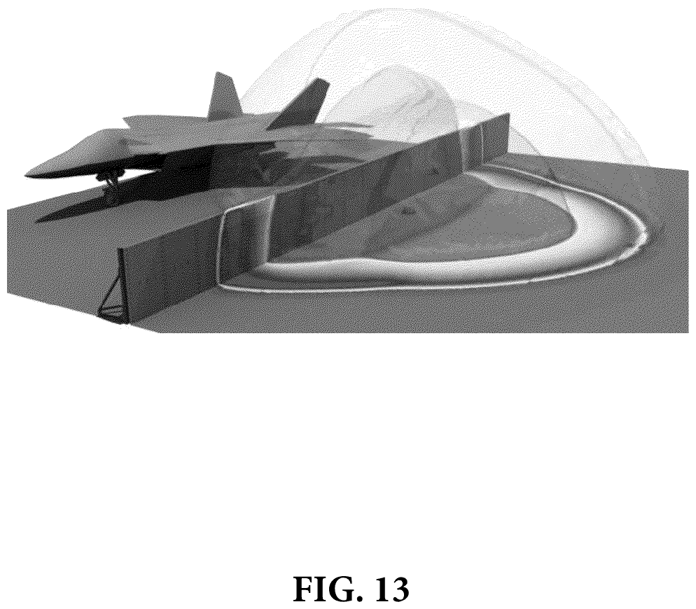

In the embodiments shown in FIGS. 1-10 and 12, both the blast mitigation panel 110 and ballistic resistant panel 130 are modular, and thus may be scalable both vertically and horizontally. The modular, expandable nature of the panels 110, 130 and thus the barrier most readily shown in FIGS. 6, 9, and 12. The panels 110, 130 are easily attached to and detached from the frame 120 to create a protective barrier that can be easily deployed in the field and customized to protect structures or assets of nearly any shape or size. Other embodiments of a protective barrier system 100 utilizing the panels 110, 130 are possible. For example, the panels (either one or both) may also be retrofit to existing buildings and products without the framing system 120. FIG. 2 is a front perspective view of one embodiment of a protective barrier 100 and FIG. 4 is a rear perspective view of the same protective barrier 100. The frame 120 can be configured to allow the system to expand horizontally and vertically or, as shown in FIGS. 6 and 9, to allow the system to form right angles around an asset or an asset area. As shown in FIG. 6, the frame 120 can be configured to allow the system to expand horizontally, vertically, and to form right angles. FIGS. 12 and 13 show examples of assembly in the field.

The system 100 may come as a kit that can be built with a specific purpose in mind, or individual components of the kit may be provided for customized builds or retrofit applications.

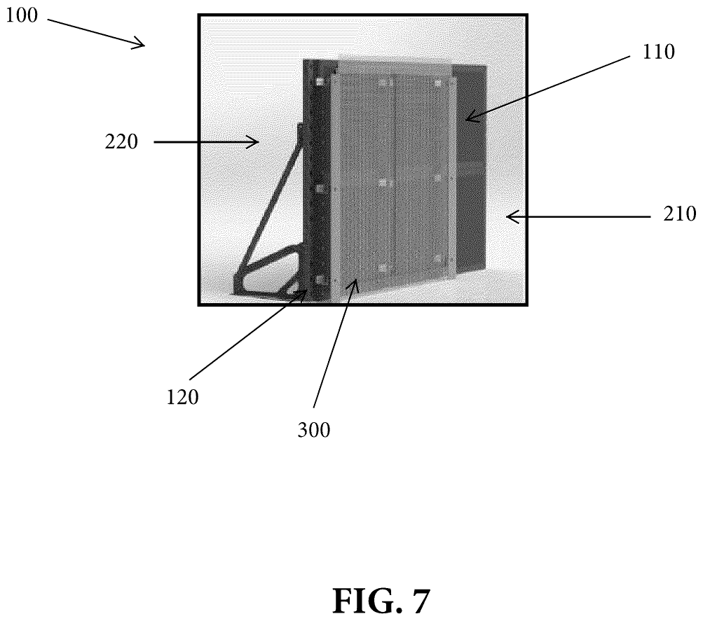

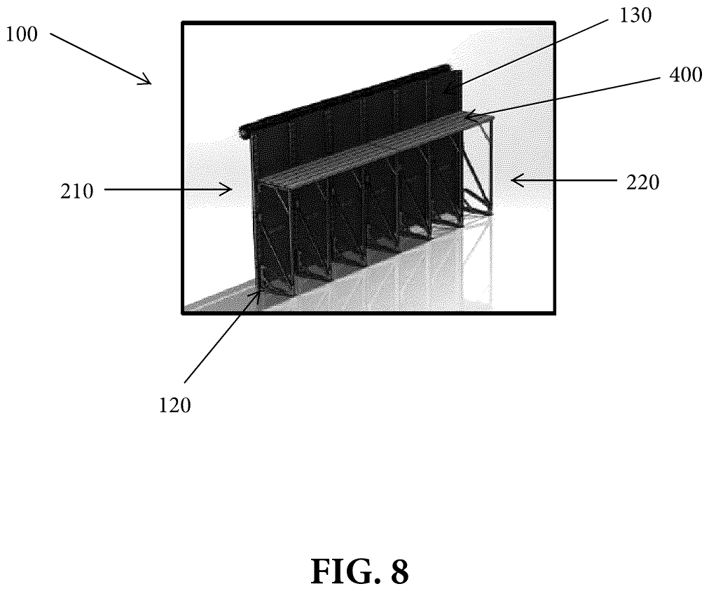

The frame 120 of the protective barrier 100 may also be fitted with various additions on the front 210 and/or the back 220. For example, an anti-climb mesh 300 can be fitted on the front 210 (i.e., the attack or threat side) of the protective barrier 100, as shown in FIG. 7. FIG. 8 shows another example of an addition to the protective barrier 100 to the back 220 (i.e., the asset side). FIG. 8 shows a platform 400 added to the asset side 220 of the protective barrier 100 which can be used for storage or as a scouting or fighting platform.

Various embodiments of the protective barrier 100 can be configured to create revetments around stationary aircraft as a means of protection. The construction of revetments around stationary aircraft protects each asset from both outside threat action and accidental initiation of explosives stored on adjacent aircraft. FIG. 13 shows one embodiment of a protective barrier 100 constructed as aircraft revetment providing protection against an explosive event.

We claim:

1. A protective barrier, comprising:
at least one blast mitigation panel configured upright on a threat side of said protective barrier; and
at least one ballistic resistant panel attached to said blast mitigation panel and configured upright on the opposite side of said threat side of said protective barrier.

2. The protective barrier of claim 1, wherein said protective barrier may be modularized and expanded horizontally.

3. The protective barrier of claim 1, wherein said protective barrier may be modularized and expanded vertically.

4. The protective barrier of claim 1 further comprising a support structure affixed or attached to said ballistic resistant panel on the opposite side of said threat said of said protective barrier.

5. The protective barrier of claim 4, wherein said support structure is a platform.

6. The protective barrier of claim 1 further comprising an anti-climb mesh affixed or attached to said blast mitigation panel on the threat side of said protective barrier.

7. The protective barrier of claim 1, wherein said blast mitigation panel has length and height dimensions of 4 feet by 4 feet.

8. The protective barrier of claim 1, further comprising at least one additional ballistic resistant panel attached to said ballistic resistant panel, wherein said additional ballistic resistant panel is attached on the opposite side of said threat side of said protective barrier.

9. A protective barrier, comprising:
at least one blast mitigation panel configured on a threat side of said protective barrier;
at least one ballistic resistant panel attached to said blast mitigation panel and configured on the opposite side of said threat side of said protective barrier; and
a frame.

10. The protective barrier of claim 9, wherein said protective barrier may be modularized and expanded horizontally.

11. The protective barrier of claim 9, wherein said protective barrier may be modularized and expanded vertically.

12. The protective barrier of claim 9 further comprising a support structure affixed or attached to said frame on the opposite side of said threat said of said protective barrier.

13. The protective barrier of claim 12, wherein said support structure is a platform.

14. The protective barrier of claim 9 further comprising an anti-climb mesh affixed or attached to said frame on the threat side of said protective barrier.

15. The protective barrier of claim 9, wherein said blast mitigation panel has length and height dimensions of 4 feet by 4 feet.

16. The protective barrier of claim 9, wherein said frame comprises steel.

17. The protective barrier of claim 9, further comprising at least one additional ballistic resistant panel attached to said ballistic resistant panel, wherein said additional ballistic resistant panel is attached on the opposite side of said threat side of said protective barrier.

18. The protective barrier system of claim 9, further comprising a hook-and-loop system on one of said ballistic resistant panels.

19. A protective barrier system comprising:
at least one section, wherein each section is comprised of:
at least one blast mitigation panel configured on a threat side of said protective system; and
at least one ballistic resistant panel attached to said blast mitigation panel and configured on the opposite side of said threat side of said protective system;
with a framing structure configured to connect a plurality of said sections.

20. The protective barrier system of claim 19, further comprising at least one additional ballistic resistant panel attached to said ballistic resistant panel, wherein said additional ballistic resistant panel is attached on the opposite side of said threat side of said protective barrier system.
